(19) United States
(12) Patent Application Publication
(10) Pub. No.: US 2024/0182645 A1
(43) Pub. Date: Jun. 6, 2024

(54) POLY(AMIC ACID) COMPOSITION, POLYIMIDE COMPOSITION, ADHESIVE, AND LAMINATE

(71) Applicant: Mitsui Chemicals, Inc., Chuo-ku, Tokyo (JP)

(72) Inventors: Masaki OKAZAKI, Chiba-shi, Chiba (JP); Ko TAKASE, Chiba-shi,Chiba (JP); Tatsuhiro URAKAMI, Ichihara-shi, Chiba (JP); Yoshihiro SAKATA, Ichikawa-shi, Chiba (JP)

(73) Assignee: Mitsui Chemicals, Inc., Chuo-ku, Tokyo (JP)

(21) Appl. No.: 18/551,672

(22) PCT Filed: Mar. 25, 2022
(86) PCT No.: PCT/JP2022/014235

§ 371 Date: Sep. 21, 2023

(30) Foreign Application Priority Data
Mar. 29, 2021 (JP) 2021-055929

(51) Int. Cl. C08G 73/10; B32B 27/28; C09J 7/30; C09J 179/08

(52) U.S. Cl. CPC C08G 73/1042; B32B 27/281; C08G 73/1071; C09J 7/30; C09J 179/08; C08G 2170/00

(57) ABSTRACT

This poly(amic acid) composition contains a poly(amic acid). Aromatic monomers account for 95 mol % or more of all monomers that constitute the poly(amic acid). The aromatic monomers include 40-95 mol % of a monomer (A) having a prescribed diphenyl ether skeleton, 0-60 mol % of a monomer (B) having a benzophenone skeleton and 0-60 mol % of a monomer (C) having a biphenyl skeleton, each relative to the total amount of monomers. The monomer (A) having a diphenyl ether skeleton includes 20 mol % or more of a monomer (A-1) having at least three aromatic rings relative to the total amount of monomers. The diamine/tetracarboxylic acid dianhydride molar ratio is 0.90-0.999.

### TECHNICAL FIELD

The present disclosure relates to a poly(amic acid) composition, a polyimide composition, an adhesive, and a laminate.

### BACKGROUND ART

In recent years, mainly in car-mounted applications, in electronic circuit substrates, semiconductor devices, and the like, there has been a demand for an adhesive having high heat resistance. Adhesives currently used are epoxy resins and epoxy resins do not have sufficient heat resistance and require a long time for the thermosetting reaction, which has been problematic.

On the other hand, thermoplastic polyimides have advantages of having high heat resistance and requiring a relatively short time for the thermosetting reaction. For this reason, use of varnishes or films including thermoplastic polyimides has been studied. For example, methods of using solvent-soluble polyimide varnishes have been

proposed (refer to Patent Literatures 1 and 2). Patent Literature 1 discloses a varnish including a polyimide copolymer obtained by using a tetracarboxylic dianhydride mixture (A) containing a tetracarboxylic dianhydride containing a specific ester group and an aliphatic or alicyclic tetracarboxylic dianhydride, and a diamine (B) including a specific alkylenediamine and/or polyoxyalkylenediamine and by causing an imidization reaction in a molar ratio (A):(B)=0.80 to 1.20:1.

Patent Literature 2 discloses a polyimide resin composition including, as an aromatic monomer, a monomer (A) having a benzophenone skeleton, and including a polyimide resin having an end group that is a diamine.

### CITATION LIST

### Patent Literature

PTL 1

Japanese Patent Application Laid-Open No. 2008-231420

PTL 2

Japanese Patent No. 5450913

### SUMMARY OF INVENTION

### Technical Problem

Manufacturing steps of electronic circuit substrates, semiconductor devices, and the

like involve heating steps such as electrode film formation and redistribution steps and hence thermoplastic polyimide films used therefor are required to have heat resistance that resists the high temperatures.

However, the polyimide obtained from the polyimide varnish of Patent Literature 1 does not have sufficient heat resistance. The polyimide obtained from the polyimide varnish of Patent Literature 2 has sufficient heat resistance but needs further improvements in the handleability of the varnish. Specifically, for polyimide vamishes, the solvents in the varnishes easily absorb moisture in the air during coating and, as a result, polyimides tend to precipitate. Polyimide films obtained in such a state of precipitation have uneven film surfaces, which adversely affect the properties in some cases.

In attempts for addressing this, the inventors of the present invention have found that vamishes including a poly(amic acid) can be provided to thereby considerably suppress white precipitate. On the other hand, they have found a new problem in which polyimide films obtained from the poly(amic acid) varnishes have low dissolvability in solvents (re-dissolvability).

In manufacturing steps of electronic circuit substrates, semiconductor devices, and

the like, thermoplastic polyimide films having been provided as adhesives are desirably peeled without adhesive residues. The peeling methods are laser liftoff (LLO), mechanical peeling, and methods of using a solvent or the like to cause dissolution-removal; from the viewpoint of performing easy peeling at low costs, dissolution-removal using a solvent or the like, in other words, high re-dissolvability of the polyimide films is desirable.

Under such circumstances, the present disclosure has been made: an object is to provide a poly(amic acid) composition that has high handleability and can provide a polyimide film having high heat resistance and high re-dissolvability. Another object is to provide a polyimide composition, an adhesive, and a laminate that use the poly(amic acid) composition.

### Solution to Problem

A poly(amic acid) composition according to the present disclosure includes a poly(amic acid), wherein monomers constituting the poly(amic acid) include, relative to a total amount of the monomers constituting the poly(amic acid), 95 mol % or more of an aromatic monomer having a main chain not having an aliphatic chain having 3 or more carbon atoms; the aromatic monomer includes, relative to the total amount of the monomers constituting the poly(amic acid), 40 to 95 mol % of a monomer (A) having a diphenyl ether skeleton represented by General formula (1) or (2), the monomer (A) not having a biphenyl skeleton or a benzophenone skeleton, 0 to 60 mol % of a monomer (B) having a benzophenone skeleton, and 0 to 60 mol % of a monomer (C) having a biphenyl skeleton: the monomer (A) having the diphenyl ether skeleton includes, relative to the total amount of the monomers constituting the poly(amic acid), 20 mol % or more of a monomer (A-1) having three or more aromatic rings; and a molar ratio of a diamine to a tetracarboxylic dianhydride satisfies diamine/tetracarboxylic dianhydride=0.90 to 0.999, the diamine and the tetracarboxylic dianhydride serving as the monomers constituting the poly(amic acid),

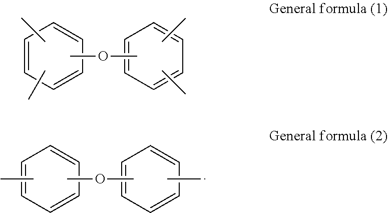

A polyimide composition according to the present disclosure includes a polyimide, wherein monomers constituting the polyimide include, relative to a total amount of the monomers constituting the polyimide, 95 mol % or more of an aromatic monomer having a main chain not having an aliphatic chain having 3 or more carbon atoms: the aromatic monomer includes, relative to the total amount of the monomers constituting the polyimide, 40 to 95 mol % of a monomer (A) having a diphenyl ether skeleton represented by General formula (1) or (2), the monomer (A) not having a biphenyl skeleton or a benzophenone skeleton, 0 to 60 mol % of a monomer (B) having a benzophenone skeleton, and 0 to 60 mol % of a monomer (C) having a biphenyl skeleton: the monomer (A) having the diphenyl ether skeleton includes, relative to the total amount of the monomers constituting the polyimide, 20 mol % or more of a monomer (A-1) having three or more aromatic rings; and a molar ratio of a diamine to a tetracarboxylic dianhydride satisfies diamine/tetracarboxylic dianhydride=0.90 to 0.999, the diamine and the tetracarboxylic dianhydride serving as the monomers constituting the poly(amic acid),

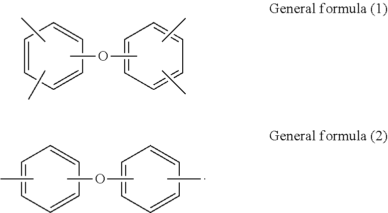

An adhesive according to the present disclosure includes the polyimide composition according to the present disclosure.

A laminate according to the present disclosure includes a substrate and a resin layer disposed on the substrate and including the polyimide composition according to the present disclosure.

### Advantageous Effects of Invention

The present disclosure can provide a poly(amic acid) composition that has high handleability and can provide a polyimide film having high heat resistance and high re-dissolvability. The present disclosure can also provide a polyimide composition, an adhesive, and a laminate that use the poly(amic acid) composition.

### BRIEF DESCRIPTION OF DRAWINGS

FIGS. 1A to 1H are schematic sectional views of an example of a process of processing a silicon substrate using, as a temporarily fixing adhesive, a polyimide composition according to the present disclosure.

### DESCRIPTION OF EMBODIMENTS

In this Description, numerical ranges described using “to” mean ranges including a value before “to” and a value after “to” respectively as the lower limit value and the upper limit value. In this Description, of numerical ranges described in series, the upper limit value or the lower limit value of a numerical range may be replaced by the upper limit value or the lower limit value of another one of the numerical ranges described in series.

As described above, polyimide varnishes, because of low dissolvability of polyimides in solvents, tend to generate white precipitate during storage and have low handleability. In particular, such a tendency is strong for polyimides including large amounts of rigid structures derived from aromatic monomers.

In order to address this, poly(amic acid) varnishes can be provided, so that, even in the case of poly(amic acid)s having rigid structures, white precipitate can be considerably suppressed. On the other hand, such poly(amic acid) varnishes provide polyimide films having low dissolvability in solvents (re-dissolvability), which is a newly found problem.

In the present disclosure, a poly(amic acid) having, at a molecular end, an acid anhydride group is used (specifically, the amount of tetracarboxylic dianhydride constituting the poly(amic acid) is made larger than the amount of diamine constituting the poly(amic acid)), so that, even in the case of a rigid poly(amic acid), interaction within molecular chains or between molecular chains of the resultant polyimide is inferentially reduced, to improve the dissolvability (re-dissolvability) of the resultant polyimide film in a solvent. Thus, the varnish in which precipitation is suppressed has improved handleability and a polyimide film having high heat resistance and high re-dissolvability can be obtained. Hereinafter, features according to the present invention will be described.

### 1. Poly(Amic Acid) Composition

A poly(amic acid) composition according to the present disclosure includes a specific poly(amic acid) and, as needed, may further include another optional component such as a solvent.

### 1-1. Poly(Amic Acid)

The poly(amic acid) is a polymer obtained by polycondensation of a tetracarboxylic dianhydride and a diamine. In other words, the monomers constituting the poly(amic acid) include a tetracarboxylic dianhydride and a diamine.

The monomers constituting the poly(amic acid) include 95 mol % or more of an aromatic monomer having a main chain not having an aliphatic chain having 3 or more carbon atoms relative to the total amount of the monomers constituting the poly(amic acid).

When 95 mol % or more of the aromatic monomer is included, the resultant polyimide can have improved heat resistance. From the viewpoint of further improving heat resistance of the resultant polyimide, the monomers constituting the poly(amic acid) are preferably constituted by an aromatic monomer.

### [Aromatic Monomer]

The aromatic monomer constituting the poly(amic acid) includes a monomer (A) not having a biphenyl skeleton or a benzophenone skeleton but having a diphenyl ether skeleton (hereafter, also referred to as “monomer (A) having a diphenyl ether skeleton”) and may further include, as needed, at least one of a monomer (B) having a benzophenone skeleton or a monomer (C) having a biphenyl skeleton.

### (Monomer (A) Having Diphenyl Ether Skeleton)

The monomer (A) having a diphenyl ether skeleton has, as described above, a diphenyl ether skeleton represented by General formula (1) or (2). The monomer (A) having a diphenyl ether skeleton can provide appropriate rigidity to the poly(amic acid) and can provide heat resistance to the resultant polyimide.

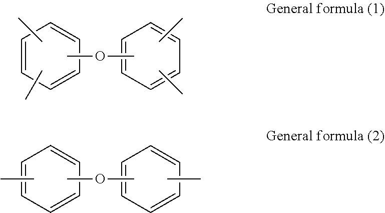

The monomer (A) having a diphenyl ether skeleton preferably includes a monomer (A-1) having three or more aromatic rings. The aromatic rings of the monomer (A-1) having three or more aromatic rings are preferably benzene rings. The monomer (A-1) having three or more aromatic rings may be an aromatic tetracarboxylic dianhydride or may be an aromatic diamine.

Examples of the aromatic tetracarboxylic dianhydride serving as the monomer (A-1) having three or more aromatic rings include 4,4′-(4,4′-isopropylidenediphenoxy)bisphthalic anhydride, 1,3-bis(3,4-dicarboxyphenoxy)benzene dianhydride, and 1,4-bis(3,4-dicarboxyphenoxy)benzene dianhydride. Other examples of the aromatic tetracarboxylic dianhydride serving as the monomer (A-1) having three or more aromatic rings include the following compounds.

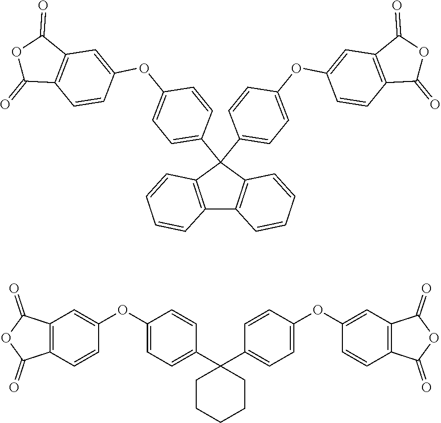 [SMILES: O=C1OC(=O)c2cc(Oc3ccc(C4(c5ccc(Oc6ccc7c(c6)C(=O)OC7=O)cc5)c5ccccc5-c5ccccc54)cc3)ccc21 ; O=C1OC(=O)c2cc(Oc3ccc(C4(c5ccc(Oc6ccc7c(c6)C(=O)OC7=O)cc5)CCCCC4)cc3)ccc21]

Examples of the aromatic diamine serving as the monomer (A-1) having three or more aromatic rings include an aromatic diamine represented by General formula (3).

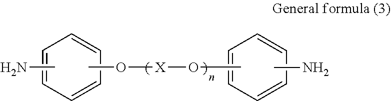

In General formula (3), X is an arylene group having 6 to 10 carbon atoms or a group represented by Formula (B) below and n represents an integer of 1 to 3. From the viewpoint of availability, n is preferably 1.

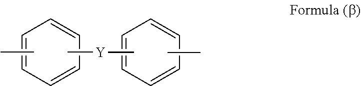

In Formula (B) above, Y represents a divalent group selected from the group consisting of an oxygen atom, a sulfur atom, a sulfonyl group, a methylene group, a fluorene moiety, and —CR¹R²— (R¹ and R² are a substituted or unsubstituted alkyl group having 1 to 3 carbon atoms or a phenyl group).

Examples of, as R¹ and R², the alkyl group having 1 to 3 carbon atoms include a methyl group, an ethyl group, a propyl group, and a trifluoropropyl group. For example, —CR¹R²— may be an isopropylidene group or a hexafluoroisopropylidene group. R¹ and R² may be linked together to form a ring. Examples of the ring formed by linking R¹ and R² together include a cyclohexane ring and a cyclopentane ring; to such rings, aromatic rings such as benzene rings may be fused. Such linking groups have three-dimensionally distributed structures and hence tend to improve the re-dissolvability of the resultant polyimide.

The compound represented by General formula (3) has an appropriately bulky

group and has a structure in which the molecular chain is freely movable and hence packing between polyimide molecular chains tends to be suppressed inferentially. This inferentially results in improved re-dissolvability of the polyimide film in a solvent.

Other examples of the aromatic diamine serving as the monomer (A-1) including three or more aromatic rings include bis[4-(3-aminophenoxy)phenyl] sulfide, 1,3-bis(3-aminophenoxy)benzene, 1,3-bis(4-aminophenoxy)benzene, 1,4-bis(4-aminophenoxy)benzene, 1,4-bis(3-aminophenoxy)benzene, 1,3-bis(3-(3-aminophenoxy)phenoxy)benzene, 1,3-bis(3-(4-aminophenoxy)phenoxy)benzene, 1,3-bis(4-(3-aminophenoxy)phenoxy)benzene, 1,3-bis(3-(3-aminophenoxy)phenoxy)-2-methylbenzene, 1,3-bis(3-(4-aminophenoxy)phenoxy)-4-methylbenzene, 1,3-bis(4-(3-aminophenoxy)phenoxy)-2-ethylbenzene, 1,3-bis(3-(2-aminophenoxy)phenoxy)-5-sec-butylbenzene, 1,3-bis(4-(3-aminophenoxy)phenoxy)-2,5-dimethylbenzene, 1,3-bis(4-(2-amino-6-methylphenoxy)phenoxy)benzene, 1,3-bis(2-(2-amino-6-ethylphenoxy)phenoxy)benzene, 1,3-bis(2-(3-aminophenoxy)-4-methylphenoxy)benzene, 1,3-bis(2-(4-aminophenoxy)-4-tert-butylphenoxy)benzene, 1,4-bis(3-(3-aminophenoxy)phenoxy)-2,5-di-tert-butylbenzene, 1,4-bis(3-(4-aminophenoxy)phenoxy)-2,3-dimethylbenzene, 1,4-bis(3-(2-amino-3-propylphenoxy)phenoxy)benzene, 1,2-bis(3-(3-aminophenoxy)phenoxy)-4-methylbenzene, 1,2-bis(3-(4-aminophenoxy)phenoxy)-3-n-butylbenzene, 1,2-bis(3-(2-amino-3-propylphenoxy)phenoxy)benzene, 4,4′-bis(4-aminophenyl)-1,4-diisopropylbenzene, bis[4-(3-aminophenoxy)phenyl]methane, bis[4-(4-aminophenoxy)phenyl]methane, 2,2-bis[4-(3-aminophenoxy)phenyl]propane, 2,2-bis[4-(4-aminophenoxy)phenyl]propane, 2,2-bis[3-(3-aminophenoxy)phenyl]-1,1,1,3,3,3-hexafluoropropane, 2,2-bis[4-(4-aminophenoxy)phenyl]-1, 1, 1,3,3,3-hexafluoropropane, bis[4-(4-aminophenoxy)phenyl] ketone, bis[4-(4-aminophenoxy)phenyl] sulfide, bis[4-(3-aminophenoxy)phenyl] sulfoxide, bis[4-(aminophenoxy)phenyl] sulfoxide, bis[4-(3-aminophenoxy)phenyl] sulfone, and bis[4-(4-aminophenoxy)phenyl] sulfone. Of these, more preferred are 1,3-bis(3-aminophenoxy)benzene, 1,3-bis(4-aminophenoxy)benzene, and aromatic diamines represented by General formula (3) (preferably 2,2-bis[4-(4-aminophenoxy)phenyl]propane). In particular, from the viewpoint of re-dissolvability, more preferred are 1,3-bis(3-aminophenoxy)benzene, 1,3-bis(4-aminophenoxy)benzene, and bis[4-(3-aminophenoxy)phenyl] sulfide: from the viewpoint of a mechanical property (elongation), preferred is 2,2-bis[4-(4-aminophenoxy)phenyl]propane.

Other examples of the aromatic diamine serving as the monomer (A-1) having three or more aromatic rings include diamines represented by formulas below.

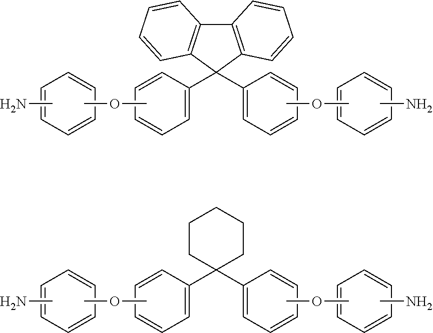

In particular, the monomer (A-1) having three or more aromatic rings preferably includes the above-described aromatic diamine. The lower limit of the content of the monomer (A-1) having three or more aromatic rings is, from the viewpoint of obtaining a polyimide having high heat resistance, relative to the total amount of the monomers constituting the poly(amic acid), preferably 20 mol % or more, more preferably 30 mol % or more, still more preferably 40 mol % or more. The upper limit of the content of the monomer (A-1) having three or more aromatic rings is, from the viewpoint of obtaining a polyimide having high heat resistance, preferably 80 mol % or less, more preferably 70 mol % or less, still more preferably 60 mol % or less.

The monomer (A) having a diphenyl ether skeleton may further include, in addition to the above-described monomer, another monomer (A-2) having a diphenyl ether skeleton.

The other monomer (A-2) having a diphenyl ether skeleton can be an aromatic tetracarboxylic dianhydride having a diphenyl ether skeleton represented by General formula (1) (preferably 4,4′-oxydiphthalic dianhydride). The aromatic tetracarboxylic dianhydride tends to improve the flexibility of the poly(amic acid) and tends to improve the re-dissolvability of the resultant polyimide.

### (Monomer (B) Having Benzophenone Skeleton)

The aromatic monomer constituting the poly(amic acid) may further include a monomer (B) having a benzophenone skeleton. The monomer (B) having a benzophenone skeleton can be used as long as it does not considerably degrade the re-dissolvability of the poly(amic acid) (or the resultant polyimide), to thereby improve heat resistance. The monomer (B) having a benzophenone skeleton may be an aromatic tetracarboxylic dianhydride having a benzophenone skeleton or may be an aromatic diamine having a benzophenone skeleton.

Examples of the aromatic tetracarboxylic dianhydride having a benzophenone

skeleton include the following compounds.

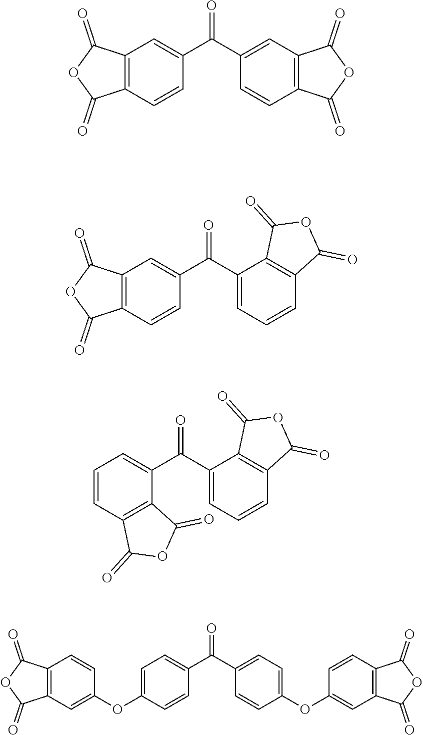 [SMILES: O=C(c1ccc2c(c1)C(=O)OC2=O)c1ccc2c(c1)C(=O)OC2=O ; O=C1OC(=O)c2cc(C(=O)c3cccc4c3C(=O)OC4=O)ccc21 ; O=C1OC(=O)c2c1cccc2C(=O)c1cccc2c1C(=O)OC2=O ; O=C(c1ccc(Oc2ccc3c(c2)C(=O)OC3=O)cc1)c1ccc(Oc2ccc3c(c2)C(=O)OC3=O)cc1]

Examples of the aromatic diamine having a benzophenone skeleton include 3,3′-diaminobenzophenone, 3,4′-diaminobenzophenone, 4,4′-diaminobenzophenone, 4,4′-bis[4-(4-amino-α,α-dimethylbenzyl)phenoxy]benzophenone, and a compound represented by the following Formula (4).

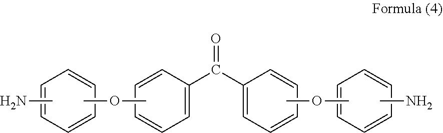

In particular, the monomer (B) having a benzophenone skeleton preferably includes

an aromatic tetracarboxylic dianhydride having a benzophenone skeleton.

### (Monomer (C) Having Biphenyl Skeleton)

The aromatic monomer constituting the poly(amic acid) preferably further includes a monomer (C) having a biphenyl skeleton. The monomer (C) having a biphenyl skeleton tends to improve the rigidity of the poly(amic acid) and tends to improve the heat resistance of the resultant polyimide. The monomer (C) having a biphenyl skeleton may be an aromatic tetracarboxylic dianhydride having a biphenyl skeleton or may be an aromatic diamine having a biphenyl skeleton.

Examples of the aromatic tetracarboxylic dianhydride having a biphenyl skeleton include 3,3′,4,4′-biphenyltetracarboxylic dianhydride, 2,3′,3,4′-biphenyltetracarboxylic dianhydride, 4,4′-bis(3,4-dicarboxyphenoxy)biphenyl dianhydride, and 2,2′,3,3′-biphenyltetracarboxylic dianhydride. Of these, preferred are 4,4′-bis(3,4-dicarboxyphenoxy)biphenyl dianhydride, 2,2′,3,3′-biphenyltetracarboxylic dianhydride, and 3,3′,4,4′-biphenyltetracarboxylic dianhydride.

Examples of the aromatic diamine having a biphenyl skeleton include 4,4′-bis(3-aminophenoxy)biphenyl, 4,4′-bis(4-aminophenoxy)biphenyl, 3,3′-bis(4-aminophenoxy)biphenyl, 4,4′-bis(4-aminophenoxy)biphenyl, 2,2′-bis(trifluoromethyl)-1,1′-biphenyl-4,4′-diamine, 3,3′-dimethylbenzidine, 3,4′-dimethylbenzidine, and 4,4′-dimethylbenzidine. Of these, preferred are 4,4′-bis(3-aminophenoxy)biphenyl, 4,4′-bis(4-aminophenoxy)biphenyl, 3,3′-bis(4-aminophenoxy)biphenyl, and 2,2′-bis(trifluoromethyl)-1,1′-biphenyl-4,4′-diamine.

In particular, from the viewpoint of facilitating improvement in the heat resistance of the resultant polyimide, the monomer (C) having a biphenyl skeleton preferably includes an aromatic tetracarboxylic dianhydride having a biphenyl skeleton.

Thus, the acid dianhydride serving as a monomer constituting the poly(amic acid) preferably includes at least one of an aromatic tetracarboxylic dianhydride having a biphenyl skeleton (monomer (C) having a biphenyl skeleton) or an aromatic tetracarboxylic dianhydride having a benzophenone skeleton (monomer (B) having a benzophenone skeleton) and the diamine serving as a monomer constituting the poly(amic acid) preferably includes an aromatic diamine having a diphenyl ether skeleton (monomer (A) having a diphenyl ether skeleton).

### (Composition)

The aromatic monomer constituting the poly(amic acid) preferably includes, relative to the total amount of the monomers constituting the poly(amic acid), 40 to 95 mol % of the monomer (A) having a diphenyl ether skeleton, 0 to 60 mol % of the monomer (B) having a benzophenone skeleton, and 0 to 60 mol % of the monomer (C) having a biphenyl skeleton. The total amount of the monomer (B) having a benzophenone skeleton and the monomer (C) having a biphenyl skeleton relative to the total amount of the monomers constituting the poly(amic acid) is more preferably 5 to 60 mol %.

From the viewpoint that the heat resistance is a priority, preferably, the aromatic monomer constituting the poly(amic acid) includes, relative to the total amount of the monomers constituting the poly(amic acid), 40 to 70 mol % of the monomer (A) having a diphenyl ether skeleton, 5 to 30 mol % of the monomer (B) having a benzophenone skeleton, and 25 to 45 mol % of the monomer (C) having a biphenyl skeleton. On the other hand, from the viewpoint of (with the re-dissolvability being ensured) facilitating further improvement in the heat resistance of the resultant polyimide, preferably, the aromatic monomer constituting the poly(amic acid) includes, relative to the total amount of the monomers constituting the poly(amic acid), 40 to 60 mol % of the monomer (A) having a diphenyl ether skeleton, 0 to 5 mol % of the monomer (B) having a benzophenone skeleton, and 40 to 45 mol % of the monomer (C) having a biphenyl skeleton.

Similarly, from this viewpoint, the ratio (B)/((B)+(C)) of the monomer (B) having a benzophenone skeleton relative to the total amount of the monomer (B) having a benzophenone skeleton and the monomer (C) having a biphenyl skeleton can be, for example, 0.3 or less, preferably 0.2 or less. In such a case where the (C) content ratio is increased, (with the re-dissolvability being ensured) the heat resistance, in particular, the glass transition temperature (Tg) of the resultant polyimide can be further increased.

The monomer composition of the poly(amic acid) can be determined by performing hydrolysis using a strong base such as sodium hydroxide or potassium hydroxide and by subjecting the separated components to NMR analysis.

### [Other Monomer]

The monomers constituting the poly(amic acid) may further include, as needed, in addition to the aromatic monomer, another monomer such as an aliphatic monomer or an alicyclic monomer.

### [Properties of Poly(Amic Acid)]

In order to provide the poly(amic acid) having, at a molecular end, an acid anhydride group, the amount of the tetracarboxylic dianhydride component (a mol) is made larger than the amount of the diamine component (b mol) in the reaction. Specifically, the molar ratio of the diamine (b mol) to the tetracarboxylic dianhydride (a mol), the diamine and the tetracarboxylic dianhydride constituting the poly(amic acid), is preferably b/a=0.90 to 0.999, more preferably 0.950 to 0.995, still more preferably 0.970 to 0.995. When b/a is 0.999 or less, the resultant polyimide tends to have, at a molecular end, an acid anhydride group, so that re-dissolvability tends to be obtained. b/a can also be determined as the charging ratio between the tetracarboxylic dianhydride component (a mol) and the diamine component (b mol) for the reaction.

The poly(amic acid) may be a random polymer or may be a block polymer.

The poly(amic acid) preferably has an intrinsic viscosity (n) of 0.4 to 1.5 dL/g, more preferably 0.5 to 1.5 dL/g. The intrinsic viscosity (n) of the poly(amic acid) is a value measured, for the poly(amic acid) dissolved so as to have a concentration of 0.5 g/dL in N-methyl-2-pyrrolidone (NMP), at 25° C. using an Ubbelohde viscosity tube. When the poly(amic acid) has an intrinsic viscosity (η) of 0.4 dL/g or more, the resultant polyimide film tends not to become brittle. When the poly(amic acid) has an intrinsic viscosity (n) of 1.5 dL/g or less, a film can be formed with an appropriately ensured solid content concentration and hence high handleability is provided. The intrinsic viscosity (η) of the poly(amic acid) is the average of values of the poly(amic acid) dissolved so as to have a concentration of 0.5 g/dL in N-methyl-2-pyrrolidone (NMP), the values being measured at 25° C. three times using an Ubbelohde viscosity tube.

The intrinsic viscosity (n) of the poly(amic acid) can be adjusted by changing the ratio of the diamine to the acid dianhydride serving as the monomers constituting the poly(amic acid).

The poly(amic acid) is imidized to form a polyimide (film) that can have heat

resistance (Tg, Tas) and re-dissolvability described later.

### 1-2. Other Component

The poly(amic acid) composition according to the present disclosure may further include, as needed, in addition to the above-described poly(amic acid), another component. For example, the poly(amic acid) composition may further include a solvent. The solvent may be a solvent used for preparation of the poly(amic acid) and is not particularly limited as long as it is a solvent in which the above-described diamine component and tetracarboxylic dianhydride component can be dissolved. Examples include aprotic solvents and alcohol-based solvents.

Examples of the aprotic solvents include N-methyl-2-pyrrolidone, N,N-dimethylformamide, N,N-dimethylacetamide, dimethyl sulfoxide, hexamethylphosphoramide, 1,3-dimethyl-2-imidazolidinone, 3-methoxy-N,N-dimethylpropanamide; and ether-based compounds such as 2-methoxyethanol, 2-ethoxyethanol, 2-(methoxymethoxy)ethoxyethanol, 2-isopropoxyethanol, 2-butoxyethanol, tetrahydrofurfuryl alcohol, diethylene glycol, diethylene glycol monomethyl ether, diethylene glycol monoethyl ether, diethylene glycol monobutyl ether, triethylene glycol, triethylene glycol monoethyl ether, tetraethylene glycol, 1-methoxy-2-propanol, 1-ethoxy-2-propanol, dipropylene glycol, dipropylene glycol monomethyl ether, dipropylene glycol monoethyl ether, tripropylene glycol monomethyl ether, polyethylene glycol, polypropylene glycol, tetrahydrofuran, dioxane, 1,2-dimethoxyethane, diethylene glycol dimethyl ether, and diethylene glycol diethyl ether.

Examples of the alcohol-based solvents include methanol, ethanol, 1-propanol, 2-propanol, tert-butyl alcohol, ethylene glycol, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, 1,2,6-hexanetriol, and diacetone alcohol.

Such solvents may be included alone or in combination of two or more thereof.

Of these, preferred are N,N-dimethylacetamide, N-methyl-2-pyrrolidone, 1,3-dimethyl-2-imidazolidinone, 3-methoxy-N,N-dimethylpropanamide, and mixed solvents thereof.

In the poly(amic acid) composition (varnish), the concentration of the resin solid content is, from the viewpoint of, for example, improving the coatability, preferably 5 to 50wt %, more preferably 10 to 30wt %.

### (Effects)

The poly(amic acid) composition has high handleability. Specifically, during storage for a certain period, the varnish tends not to undergo blushing due to precipitation of the poly(amic acid). The handleability refers to the following: in a thermo-hygrostat chamber (room temperature: 23 to 24° C., relative humidity: 58 to 60%), for 2.5 mL of a varnish dropped onto a glass and observed at predetermined intervals, the time elapsed until blushing occurring from the peripheral portion of the varnish is observed is, for example, more than 20 minutes.

### (Method for Producing Poly(Amic Acid) Composition)

The poly(amic acid) composition can be obtained by adding, to a solvent, a tetracarboxylic dianhydride component and a diamine component and subjecting these to a dehydration reaction. The types and amount ratios of the solvent, the tetracarboxylic dianhydride component, and the diamine component used have been described above.

The reaction for obtaining the amic acid composition is preferably performed by heating the above-described tetracarboxylic dianhydride and diamine in a solvent at a relatively low temperature (temperature at which imidization does not occur). The temperature at which imidization does not occur may be specifically 5 to 120° C., more preferably 25 to 80° C. The reaction is preferably performed in an environment in which imidization catalysts (such as triethylamine) are substantially not present.

### 2. Polyimide Composition

The polyimide composition according to the present disclosure includes a specific polyimide obtained by imidizing the above-described poly(amic acid) included in the poly(amic acid) composition. The polyimide composition including the specific polyimide can be obtained by heating the above-described poly(amic acid) composition to imidize the poly(amic acid). The polyimide composition according to the present disclosure may be a film.

The temperature at which the poly(amic acid) is imidized may be, for example, 150 to 300° C. Thus, in the case of rapidly increasing the temperature of the coating film to more than 300° ° C., before evaporation of the solvent from the coating film, the poly(amic acid) in the surface of the coating film is imidized. As a result, the solvent remaining in the coating film may form bubbles or irregularities in the surface of the coating film. Thus, in the temperature region of 50 to 300° C., the temperature of the coating film is preferably gradually increased. Specifically, in the temperature region of 50 to 300° C., the temperature increase rate is preferably set to 0.25 to 50° C./min, more preferably 1 to 40° C./min, still more preferably 2 to 30° C./min. The heating is preferably performed in the temperature region of 50 to 300° ° C. for 30 minutes. For preferred imidization conditions, the temperature is increased in the air atmosphere from 50° ° C. to 250° C. at 5° C./min and heating at 250° C. for 30 minutes is performed.

The temperature increase may be performed continuously or stepwise (step by step) but preferably continuously performed from the viewpoint of suppressing appearance defects of the resultant polyimide film. In the above-described entire temperature range, the temperature increase rate may be constant or may be changed at intermediate points.

Thus, the polyimide composition (a polyimide, a polyimide film, or the like) obtained by subjecting a poly(amic acid) composition according to the present invention to heating under the above-described conditions and imidization preferably satisfies properties below.

### (1) Heat Resistance

### (Glass Transition Temperature (Tg))

The glass transition temperature of the polyimide film is preferably 130° C. or more and less than 260° C., more preferably 160 to 220° C. Polyimides having glass transition temperatures in such a range have high heat resistance and hence are suitable as adhesives used for, for example, electronic circuit substrates and semiconductor devices.

The glass transition temperature of the polyimide film can be measured in the following manner. The obtained polyimide film is cut to a size of 5 mm in width and 22 mm in length. The glass transition temperature (Tg) of the obtained sample is measured using a thermal analysis apparatus (such as TMA-50 manufactured by SHIMADZU CORPORATION). Specifically, in the air atmosphere, the measurement is performed under conditions of a temperature increase rate of 5° C./min and a tension mode (100 mN) to determine a TMA curve; in the TMA curve, with respect to the point of inflection due to glass transition, curves before and after the point of inflection are extrapolated, so that the value of the glass transition temperature (Tg) can be determined.

### (Temperature of 5% Weight Loss (T_{d5}))

The temperature of 5% weight loss (T_{d5}) of the polyimide film in the air atmosphere is, from the viewpoint similar to that described above, preferably 450° C. or more, more preferably 500° C. or more. The upper limit of Tas of the polyimide is not particularly limited but can be set to, for example, 600° C.

The temperature of 5% weight loss (T_{d5}) of the polyimide film can be measured using a thermogravimetric analysis apparatus. Specifically, it can be measured in the following manner: the sample is sampled: the scanning temperature is set to 30 to 900° C.; in the air atmosphere, the sample is heated under a condition of a temperature increase rate of 10° C./min and the temperature at which the mass of the sample decreases by 5% is measured.

Tg or T_{d5} of the polyimide film can be adjusted using the monomer composition of the poly(amic acid). For example, the content of the monomer (A) constituting the poly(amic acid) and having a diphenyl ether skeleton (preferably an aromatic diamine having a diphenyl ether skeleton) can be increased or the content of the monomer (C) having a biphenyl skeleton (preferably an aromatic tetracarboxylic dianhydride having a biphenyl skeleton) can be increased, so that Tg or T_{d5} of the resultant polyimide film can be increased.

### (2) Re-Dissolvability

The polyimide film obtained by imidizing the poly(amic acid) composition preferably has, from the viewpoint of, in the case of being used as, for example, an adhesive, being dissolved in a solvent to facilitate peeling, high dissolvability in the solvent. Specifically, the polyimide film obtained by imidizing the poly(amic acid) composition and having a thickness of 20 μm is immersed in N-methyl-2-pyrrolidone (NMP) under conditions described later at 80° C. for 20 minutes and subsequently filtered through filter paper to determine the dissolution ratio represented by Expression (1) below, which is preferably 60% or more, more preferably 80% or more, still more preferably 95% or more.

dissolution ratio (%)={1−[(weight of filter paper after filtration and drying)−(weight of filter paper before use)]/(weight of film before immersion)}×100 (1)

The re-dissolvability can be measured in the following manner.

1) The above-described poly(amic acid) composition is imidized and the resultant polyimide film is cut out to dimensions of 20 μm in thickness and 2.0 cm×2.0 cm to prepare a sample: the weight (weight of film before immersion) of the sample is measured. For the imidization conditions, as described above, the temperature increase rate in the air atmosphere in the temperature region of 50 to 300° C. is preferably set to 0.25 to 50° C./min, more preferably 1 to 40° C./min, still more preferably 2 to 30° C./min. The heating can be performed in the temperature region of 50 to 300° C. for 30 minutes. For preferred imidization conditions, in the air atmosphere, the temperature is increased from 50° C. to 250° C. at 5° C./min and heating at 250° C. is performed for 30 minutes. In addition, the weight of the filter paper before use is measured in advance.

2) Subsequently, the sample is added to N-methyl-2-pyrrolidone (NMP) to provide a sample liquid at a concentration of 1 mass %; the obtained sample liquid is left at rest for 20 minutes in an oven heated at 80° C. Subsequently, the sample liquid is taken out of the oven, filtered through the filter paper, and then subjected to reduced-pressure drying at 100° C. Subsequently, the weight of the filter paper after filtration and drying is measured.

3) The measured values in 1) and 2) above are substituted into Expression (1) above to calculate the dissolution ratio. These procedures (the above-described procedures 1) to 3)) are performed with n=2 and the average value is determined as the dissolution ratio (%). Note that the size (such as thickness) of the sample is preferably the above-described size but may alternatively be a somewhat different size.

The re-dissolvability of the polyimide film can be adjusted using the type of the molecular-end group or the composition of the poly(amic acid) serving as the precursor of the polyimide film. For example, the poly(amic acid) is provided so as to have a molecular-end group that is an acid anhydride group, so that the resultant polyimide tends to have improved re-dissolvability. For monomers constituting the poly(amic acid), the content of the monomer (A) having a diphenyl ether skeleton (preferably, the aromatic tetracarboxylic dianhydride having a diphenyl ether skeleton) can be increased, so that the resultant polyimide tends to have improved re-dissolvability.

Note that the polyimide film actually prepared (in other words, a polyimide film prepared to have a thickness for use) may also satisfy such a dissolution ratio.

### 3. Applications of Poly(Amic Acid) Composition

The poly(amic acid) composition according to the present disclosure has high handleability and can provide a polyimide having high heat resistance and high re-dissolvability. Thus, the polyimide composition obtained from the poly(amic acid) composition according to the present disclosure can be used particularly in applications in which heat resistance and re-dissolvability are required: for example, the polyimide composition can be used as adhesives, sealing members, insulating materials, substrate materials, or protective materials in electronic circuit substrate members, semiconductor devices, surge parts, and the like.

Specifically, a laminate including a substrate and a resin layer disposed on the substrate and including the polyimide composition according to the present disclosure can be provided. Preferably, a laminate including a substrate and a resin layer disposed on the substrate in a state of being in contact with the substrate and including the polyimide composition according to the present disclosure can be provided. The material constituting the substrate is not particularly limited and may be a material ordinarily used. Specifically, the material constituting the substrate varies in accordance with the application but may be, for example, silicon, ceramic, metal, or resin. Examples of the metal include silicon, copper, aluminum, SUS, iron, magnesium, nickel, and alumina. Examples of the resin include urethane resin, epoxy resin, acrylic resin, polyimide, PET resin, polyamide, and polyamide-imide. The substrate more preferably includes at least one element selected from the group consisting of Si, Ga, Ge, and As and is still more preferably a semiconductor substrate including at least one element selected from the group consisting of Si, Ga, Ge, and As.

The laminate can be produced by, for example, using a step of applying, onto a substrate, the poly(amic acid) composition according to the present disclosure and subsequently heating the poly(amic acid) composition to cause imidization, to form a resin layer of the polyimide composition. The heating temperature of the coating film can be set to, as described above, a temperature suitable for imidization.

### Regarding Electronic Circuit Substrate Member

The polyimide composition according to the present disclosure can be used as, in a circuit substrate, in particular, a flexible circuit substrate, an insulating substrate or an adhesive material. For example, a flexible circuit substrate can include metallic foil (substrate) and an insulating layer disposed on the metallic foil and formed from the polyimide composition according to the present disclosure (obtained from the poly(amic acid) composition according to the present disclosure). The flexible circuit substrate can include an insulating resin film (substrate), an adhesive layer formed from the polyimide composition according to the present disclosure, and metallic foil.

### Regarding Semiconductor Member

The polyimide composition according to the present disclosure can be used as an adhesive material used for adhesion between semiconductor chips or adhesion between a semiconductor chip and a substrate, a protective member for protection of the circuits of semiconductor chips, an embedding member for embedding of semiconductor chips (sealing member), or the like.

Specifically, the semiconductor member according to the present disclosure includes a semiconductor chip (substrate) and a resin layer disposed on at least one of the surfaces of the semiconductor chip and formed from the polyimide composition according to the present disclosure (formed from the poly(amic acid) composition according to the present disclosure). Examples of the semiconductor chip include diodes, transistors, integrated circuits (IC), and power elements. The resin layer formed from the polyimide composition may be disposed on a surface of a semiconductor chip on which terminals are formed (terminal formation surface) or may be disposed on a surface other than the terminal formation surface.

The thickness of the layer formed from the polyimide composition is preferably, for example, in a case where the polyimide composition is used to form an adhesive layer, about 1 to about 100 μm. In a case where a polyimide composition layer is formed as a circuit protective layer, the thickness is preferably about 2 to about 200 μm.

### Regarding Adhesive for Surge Part

The polyimide composition according to the present disclosure can be used as an adhesive for surge parts (surge absorbers) or a sealing member for surge parts for protecting household appliances, personal computers, transportation such as automobiles, mobile devices, power sources, servers, phones, or the like from abnormal current and voltage that affect the foregoing. The polyimide composition according to the present disclosure can be used as an adhesive or a sealing member, so that adhesion or sealing of a surge part can be achieved at low temperatures and the adhesive or the sealing member has sufficient withstand voltage and heat resistance.

Of these, the polyimide composition according to the present disclosure is preferably used as, from the viewpoint of having heat resistance and high re-dissolvability, an adhesive for a semiconductor member, an electronic circuit substrate member, a surge part, or the like, in particular, as an adhesive for a semiconductor member, an adhesive for a flexible printed substrate, an adhesive for a coverlay film, or an adhesive for a bonding sheet.

Specifically, an electronic device such as an electronic circuit substrate or a semiconductor member may be produced by using, for example, a step of preparing a laminate including a substrate, a resin layer, and a handling substrate, a step of processing the substrate, and a step of dissolving the resin layer in a solvent and peeling the processed substrate (processed article) from the handling substrate. The laminate can be obtained by, for example, applying, to one of the substrate and the handling substrate, the poly(amic acid) composition according to the present disclosure, subsequently imidizing the poly(amic acid) composition to form a layer including a polyimide composition, and subsequently bonding the other to the layer.

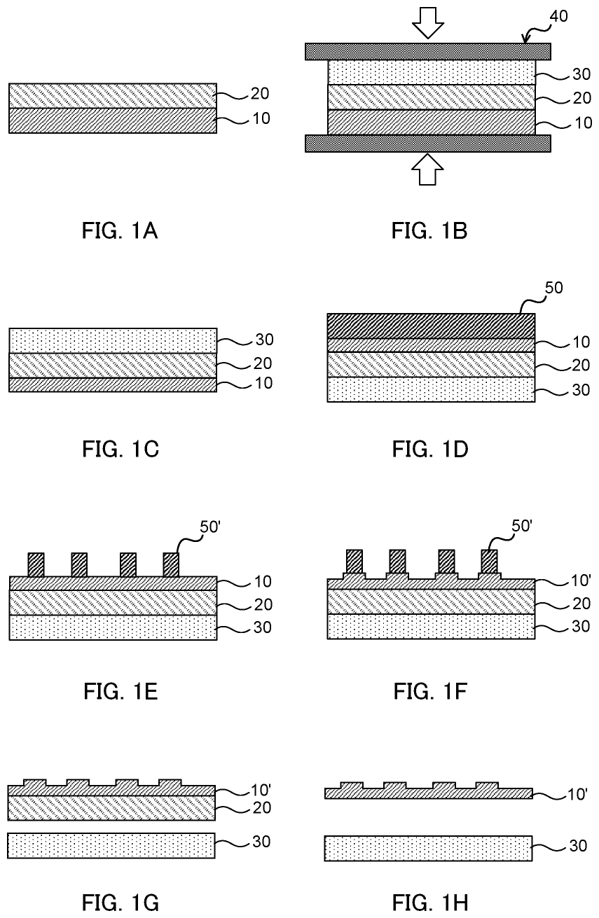

FIGS. 1A to 1H are schematic sectional views of an example of a process of using,

as a temporarily fixing adhesive, the polyimide composition according to the present disclosure to process a silicon substrate. As illustrated in FIGS. 1A to 1H, for example, the poly(amic acid) resin composition according to the present disclosure is applied onto silicon substrate 10 (substrate) and subsequently heated and imidized, to form resin layer 20 including the polyimide resin composition (refer to FIG. 1A). Subsequently, on resin layer 20, handling substrate 30 (for example, a glass substrate) is placed and they are hot-pressed together using hot-press apparatus 40 to obtain a laminate (refer to FIG. 1B). Subsequently, the back surface of silicon substrate 10 is polished to a predetermined thickness (refer to FIG. 1C). Subsequently, on polished silicon substrate 10, resist 50 is placed to form resist pattern 50′ (refer to FIG. 1E): silicon substrate 10 is etched through resist pattern 50′ to pattern silicon substrate 10 (refer to FIG. 1F). Subsequently, handling substrate 30 is peeled using a laser or by mechanical processing from resin layer 20 (refer to FIG. 1G). Subsequently, resin layer 20 is dissolved in a solvent to peel and obtain patterned silicon substrate 10′ (refer to FIG. 1H). In the process, exposure to high temperatures of 200° C. or more occurs in, for example, the step of polishing the back surface of silicon substrate 10 (refer to FIG. 1C) and the step of etching and heat-treating silicon substrate 10 (refer to FIG. IF).

In such manufacturing steps of electronic circuit substrates, semiconductor members, and the like, a substrate fixed on a handling substrate with a resin layer, as an adhesive, disposed therebetween is processed (including, for example, heating steps such as a polishing step, an etching and heat-treating step, an electrode film formation step, and a re-distribution step) and subsequently peeled together with the adhesive from the processed article without adhesive residues in some cases. By contrast, the polyimide composition according to the present disclosure (obtained from the poly(amic acid) composition according to the present disclosure) has heat resistance that resists heating steps, can be dissolved in a solvent or the like, and hence can be peeled without adhesive residues. Thus, the polyimide composition according to the present disclosure is suitable as an adhesive for an electronic circuit substrate, a semiconductor member, and the like and is particularly suitable as a temporarily fixing adhesive (an adhesive used for temporary adhesion and subsequent peeling).

### EXAMPLES

Hereinafter, the present disclosure will be described further in detail with reference

to Examples. However, this does not limit at all the scope of the present disclosure. The following are acid dianhydrides and diamines used in Examples and Comparative Examples.

### (1) Tetracarboxylic Dianhydride

Aromatic tetracarboxylic dianhydride having a diphenyl ether skeleton (monomer

(A))
ODPA: 4,4′-oxydiphthalic dianhydride
Aromatic tetracarboxylic dianhydride having a benzophenone skeleton (monomer (B))
BTDA: 3,3′,4,4′-benzophenonetetracarboxylic dianhydride
Aromatic tetracarboxylic dianhydride having a biphenyl skeleton (monomer (C))
S-BPDA: 3,3′,4,4′-biphenyltetracarboxylic dianhydride (manufactured by JFE Chemical Corporation)

### (2) Diamine

Aromatic diamine having a diphenyl ether skeleton (monomer (A))
p-BAPP: 2,2-bis(4-(4-aminophenoxy)phenyl)propane
APB-N: 1,3-bis(3-aminophenoxy)benzene (manufactured by Mitsui Chemicals, Inc.)

### Example 1

### Preparation of Poly(Amic Acid) Varnish (Poly(Amic Acid) Composition)

To a solvent prepared using NMP (N-methyl-2-pyrrolidone), two acid dianhydrides (s-BPDA and BTDA) and a diamine (APB-N) were added in a molar ratio of s-BPDA:BTDA:APB-N=0.7:0.3:0.97. The resultant mixture was stirred for 4 hours or more within a dry-nitrogen-gas-introducible flask, to obtain a poly(amic acid) varnish having a resin solid content of 20 to 25mass % and an intrinsic viscosity (n) of 0.56 dL/g.

### Formation of Film

The obtained poly(amic acid) varnish was applied onto a glass plate at a speed of 10 mm/s, subsequently subjected to a temperature increase from 50° C. to 250° C. at 5° C./min, and heated at 250° C. for 30 minutes to remove the solvent and to cause imidization. The resultant polyimide film was peeled from the glass plate, to obtain a polyimide film having a thickness of 20 μm (polyimide composition).

### Comparative Example 1

### Preparation of Polyimide Varnish (Polyimide Composition)

To a solvent prepared using NMP, two acid dianhydrides (s-BPDA and BTDA) and a diamine (APB-N) were added in a molar ratio of s-BPDA:BTDA:APB-N=0.67:0.3:1.0. The resultant mixture was stirred at 40° C. for 5 hours or more within a dry-nitrogen-gas-introducible flask equipped with a Dean-Stark and a condenser, to obtain a poly(amic acid) varnish. Subsequently, the temperature of the solution was increased and the solution was stirred at an internal temperature of 190° C. for 8 hours or more. At this time, distilled condensation water and partially evaporated NMP were collected using the Dean-Stark. After completion of the reaction, NMP was added to adjust the concentration, to obtain a pale-yellow and viscous polyimide varnish.

### Preparation of Film

The same procedures as in Example 1 were performed except that the obtained polyimide varnish was applied onto a glass plate at a speed of 10 mm/s, subsequently subjected to a temperature increase from 50° ° C. to 250° C. at 5° C./min, and heated at 250° C. for 30 minutes to remove the solvent, to obtain a polyimide film having a thickness of 20 um (polyimide composition).

### Examples 2 to 6 and Comparative Examples 2 to 3

The same procedures as in Example 1 were performed except that the types and amount ratios of the acid dianhydride and the diamine and the molar ratio of diamine/acid dianhydride were changed as described in Table 1, to prepare poly(amic acid) varnishes and to obtain polyimide films.

### (Evaluation)

The poly (amic acid) varnishes used in Examples 1 to 6 and Comparative Examples 2 to 3 and the polyimide varnish used in Comparative Example 1 were evaluated in terms of (1) intrinsic viscosity η, (2) handleability, (3) re-dissolvability, and (4) a thermal property (Tg and T_{d5}) of the resultant polyimide films in the following manner.

### (1) Intrinsic Viscosity η of Poly(Amic Acid)

Such an obtained poly(amic acid) varnish was diluted with NMP such that the concentration of the poly(amic acid) became 0.5 g/dL; the intrinsic viscosity η of the resultant solution was measured in accordance with JIS K7367-1:2002 at 25° C. using an Ubbelohde viscosity tube (size No. 1) three times and the average value was determined.

### (2) Handleability

In a thermo-hygrostat chamber (room temperature: 23 to 24° C., relative humidity: 58 to 60%), onto a glass, the poly(amic acid) varnishes were dropped each in an amount of 2.5 mL and observed at predetermined intervals. The time elapsed until blushing occurring from a peripheral portion of such a varnish was observed (blushing resistance). The shorter the time elapsed until blushing is observed, the higher the likeliness of blushing, which is evaluated as low handleability during actual use.)

### (3) Re-Dissolvability

1) The obtained polyimide film was cut out to dimensions of 2.0 cm×2.0 cm to prepare a sample and its weight (weight of film before immersion) was measured. The weight of filter paper before use was also measured in advance.

2) Subsequently, the sample was added to N-methyl-2-pyrrolidone (NMP) so as to have a concentration of 1 mass % to prepare a sample liquid: the obtained sample liquid was left at rest for 20 minutes in an oven heated at 80° C. Subsequently, the sample liquid was taken out of the oven and the dissolution state was visually observed. In addition, the sample liquid taken out was filtered through the filter paper (pore size: 5B), and then subjected to reduced-pressure drying at 100° C. Subsequently, the weight of the filter paper after filtration and drying was measured.

3) The measured values of 1) and 2) above were substituted into Expression (1) below to calculate the dissolution ratio. These procedures (the above-described procedures 1) to 3)) were performed with n=2 and the average value was determined as the dissolution ratio (%).

dissolution ratio (%)={1−[(weight of filter paper after filtration and drying)−(weight of filter paper before use)]/(weight of film before immersion)}×100 (1)

The dissolution state visually observed was evaluated in accordance with the following grades.
Good: a homogeneous system including the solvent is provided.
Fair: some undissolved residues are observed.
Poor: the shape of the film is maintained.

### (4) Thermal Property

### (Glass Transition Temperature (Tg))

The obtained polyimide film was cut to a size of 5 mm in width and 22 mm in length. The glass transition temperature (Tg) of the sample was measured with a thermal analysis apparatus (TMA-50) manufactured by SHIMADZU CORPORATION. Specifically, the measurement was performed under conditions of the air atmosphere (air gas: 50 mL/min), a temperature increase rate of 5° C./min, and a tension mode (100 mN) to determine a TMA curve: with respect to the point of inflection due to glass transition in the TMA curve, curves before and after the point of inflection were extrapolated, so that the value of the glass transition temperature (Tg) was determined.

### (Temperature of 5% Weight Loss (T_{d5}))

The temperature of 5% weight loss (T_{d5}) of the obtained polyimide film was measured using a thermogravimetric analysis apparatus (TGA-60) manufactured by SHIMADZU CORPORATION. Specifically, the obtained polyimide film (in a rough amount of about 5 mg) was accurately weighed on the apparatus: the scanning temperature was set to 30 to 900° C.: in the air atmosphere, under a stream of air gas at 50 mL/min, the sample was heated under a condition of a temperature increase rate of 10° C./min and the temperature at which the mass of the sample decreased by 5% was determined as T_{d5}.

The evaluation results of Examples 1 to 6 and Comparative Examples 1 to 3 will

be described in Table 1. Note that the molar ratio (b/a) of the diamine to the tetracarboxylic dianhydride was calculated from the charging amounts (moles) of the diamine and the tetracarboxylic dianhydride.

TABLE 1

| | | | | | Composition | | |
|---|---|---|---|---|---|---|---|
| | Diamine | | Acid dianhydride | | | Monomer | Monomer |
| | First | Second | First | Second | Diamine/acid | (A) | (B) |
| | component | component | component | component | dianhydride | (mol %) | (mol %) |
| Example 1 | APB-N | — | sBPDA | BTDA | 0.97 | 49.2 | 15.2 |
| | 0.97 | | 0.7 | 0.3 | | | |
| Example 2 | APB-N | — | sBPDA | — | 0.97 | 49.2 | 0.0 |
| | 0.97 | | 1 | | | | |
| Example 3 | APB-N | — | BTDA | — | 0.97 | 49.2 | 50.8 |
| | 0.97 | | 1 | | | | |
| Example 4 | pBAPP | — | SBPDA | — | 0.97 | 49.2 | 0.0 |
| | 0.97 | | 1 | | | | |
| Example 5 | pBAPP | — | BTDA | — | 0.97 | 49.2 | 50.8 |
| | 0.97 | | 1 | | | | |
| Example 6 | APB-N | — | sBPDA | ODPA | 0.97 | 74.6 | 0.0 |
| | 0.97 | | 0.5 | 0.5 | | | |
| Comparative | APB-N | — | sBPDA | BTDA | 1.03 | 50.8 | 15.2 |
| Example 1 | 1 | | 0.67 | 0.3 | | | |
| Comparative | APB-N | — | sBPDA | BTDA | 1.03 | 50.8 | 15.2 |
| Example 2 | 1 | | 0.67 | 0.3 | | | |
| Comparative | APB-N | — | sBPDA | BTDA | 1.01 | 50.3 | 15.1 |
| Example 3 | 1 | | 0.69 | 0.3 | | | |

| | | | | | Re-dissolvability | | | |
|---|---|---|---|---|---|---|---|---|
| | | | | | Visual | | | |
| | Composition | | | Handleability | observation | | Thermal | |
| | Monomer | | | Blushing | (after lapse | | property | |
| | (C) | | η | resistance | of 20 | Dissolution | Tg | Td5 |
| | (mol %) | Varnish | (dL/g) | (time) | minutes) | ratio (%) | (° C.) | (° C.) |
| Example 1 | 35.5 | Poly(amic | 0.56 | Good | Good | 99 | 199 | 546 |
| | | acid) | | | | | | |
| Example 2 | 50.8 | Poly(amic | 0.50 | Good | Good | 97 | 204 | 529 |
| | | acid) | | | | | | |
| Example 3 | 0.0 | Poly(amic | 0.53 | Good | Good | 99 | 194 | 509 |
| | | acid) | | | | | | |
| Example 4 | 50.8 | Poly(amic | 0.79 | Good | Fair | 72 | 246 | 483 |
| | | acid) | | | | | | |
| Example 5 | 0.0 | Poly(amic | 0.82 | Good | Fair | 70 | 233 | 476 |
| | | acid) | | | | | | |
| Example 6 | 25.4 | Poly(amic | 0.50 | Good | Good | 99 | 163 | 479 |
| | | acid) | | | | | | |
| Comparative | 34.0 | Polyimide | 0.70 | Poor | Good | 99 | 197 | 551 |
| Example 1 | | | | | | | | |
| Comparative | 34.0 | Poly(amic | 0.59 | Good | Poor | 43 | 203 | 543 |
| Example 2 | | acid) | | | | | | |
| Comparative | 34.7 | Poly(amic | 1.04 | Good | Poor | 40 | 203 | 537 |
| Example 3 | | acid) | | | | | | |

As described in Table 1, it has been demonstrated that the poly(amic acid) varnishes of Examples 1 to 6 having molar ratios of diamine/tetracarboxylic dianhydride of less than 1 have high handleability and the resultant polyimides also have high re-dissolvability. In addition, it has been demonstrated that the poly(amic acid)s of Examples 1 to 6 include the predetermined amount or more of the APB-N-derived unit that is the monomer (A-1) having three or more aromatic rings and hence the resultant polyimides also have high heat resistance.

In particular, it has been demonstrated that, when the content of s-BPDA serving as the monomer (B) having a biphenyl skeleton is increased, the resultant polyimide has further improved heat resistance (comparison between Examples 2 and 3).

By contrast, it has been demonstrated that the polyimide varnish of Comparative Example 1 tends to generate white precipitate and has low handleability. On the other hand, it has been demonstrated that the poly(amic acid) varnishes of Comparative Examples 2 and 3 have improved handleability but have molar ratios of diamine/tetracarboxylic dianhydride of more than 1 and hence the resultant polyimides have low re-dissolvability.

The present application claims priority to Japanese Patent Application No. 2021-055929 filed in the Japan Patent Office on Mar. 29, 2021. The entire contents described in the description of this application are incorporated herein by reference.

### Industrial Applicability

The poly(amic acid) composition according to the present disclosure has high handleability and can provide a polyimide film having high heat resistance and high re-dissolvability. Therefore, the obtained polyimide film is suitable as an adhesive in various fields in which high heat resistance and high re-dissolvability are required, such as electronic circuit substrate members and semiconductor devices.

1. A poly(amic acid) composition comprising a poly(amic acid),
wherein monomers constituting the poly(amic acid) include, relative to a total amount of the monomers constituting the poly(amic acid), 95 mol % or more of an aromatic monomer having a main chain not having an aliphatic chain having 3 or more carbon atoms,
the aromatic monomer includes,
relative to the total amount of the monomers constituting the poly(amic acid),
40 to 95 mol % of a monomer (A) having a diphenyl ether skeleton represented by General formula (1) or (2), the monomer (A) not having a biphenyl skeleton or a benzophenone skeleton,
0 to 60 mol % of a monomer (B) having a benzophenone skeleton, and
0 to 60 mol % of a monomer (C) having a biphenyl skeleton,
the monomer (A) having the diphenyl ether skeleton includes, relative to the total amount of the monomers constituting the poly(amic acid), 20 mol % or more of a monomer (A-1) having three or more aromatic rings, and
a molar ratio of a diamine to a tetracarboxylic dianhydride satisfies diamine/tetracarboxylic dianhydride=0.90 to 0.999, the diamine and the tetracarboxylic dianhydride serving as the monomers constituting the poly(amic acid),

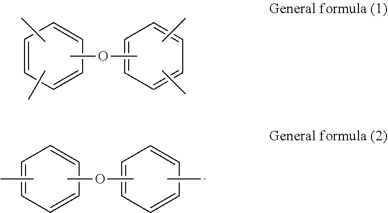

2. The poly(amic acid) composition according to claim 1,
wherein, relative to the total amount of the monomers constituting the poly(amic acid),
a total amount of the monomer (B) having the benzophenone skeleton and the monomer (C) having the biphenyl skeleton is 5 to 60 mol %.

3. The poly(amic acid) composition according to claim 1,
wherein, in the monomer (A-1) having three or more aromatic rings, the aromatic rings are benzene rings.

4. The poly(amic acid) composition according to claim 1,
wherein the monomer (A-1) having three or more aromatic rings is a compound represented by General formula (3), 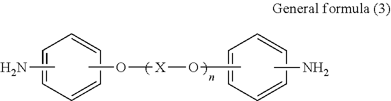
(in General formula (3),
X is an arylene group having 6 to 10 carbon atoms or a group represented by Formula (β) below, and
n represents an integer of 1 to 3) 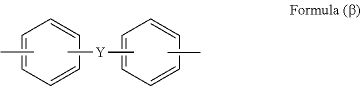
(in Formula (3),
Y represents a divalent group selected from the group consisting of an oxygen atom, a sulfur atom, a sulfonyl group, a methylene group, a fluorene moiety, and —CR¹R²— (R¹ and R² are a substituted or unsubstituted alkyl group having 1 to 3 carbon atoms or a phenyl group), and
R¹ and R² may be linked together to form a ring).

5. The poly(amic acid) composition according to claim 4,
wherein the monomer (A-1) having three or more aromatic rings includes,
an aromatic diamine selected from the group consisting of 1,3-bis(3-aminophenoxy)benzene, 1,3-bis(4-aminophenoxy)benzene, and 2,2-bis[4-(4-aminophenoxy)phenyl]propane.

6. The poly(amic acid) composition according to claim 1,
wherein the monomer (B) having the benzophenone skeleton includes,
an aromatic tetracarboxylic dianhydride selected from the group consisting of compounds below, or 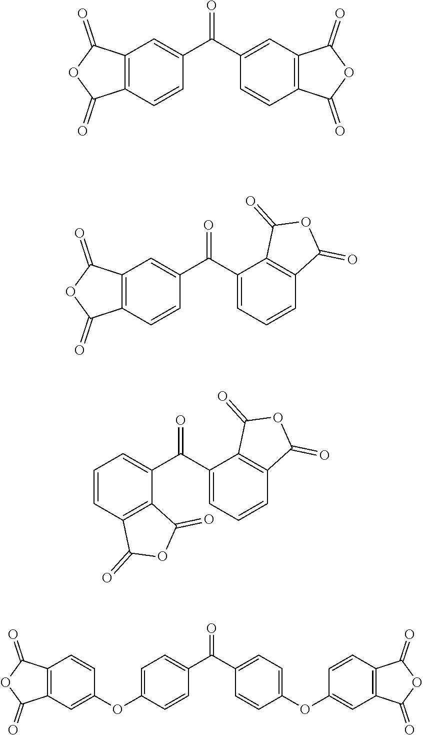 [SMILES: O=C(c1ccc2c(c1)C(=O)OC2=O)c1ccc2c(c1)C(=O)OC2=O ; O=C1OC(=O)c2cc(C(=O)c3cccc4c3C(=O)OC4=O)ccc21 ; O=C1OC(=O)c2c1cccc2C(=O)c1cccc2c1C(=O)OC2=O ; O=C(c1ccc(Oc2ccc3c(c2)C(=O)OC3=O)cc1)c1ccc(Oc2ccc3c(c2)C(=O)OC3=O)cc1]
an aromatic diamine selected from the group consisting of 3,3′-diaminobenzophenone, 3,4′-diaminobenzophenone, 4,4′-diaminobenzophenone, 4,4′-bis[4-(4-amino-α,α-dimethylbenzyl)phenoxy]benzophenone, and a compound represented by Formula (4) below,

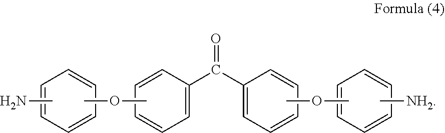

7. The poly(amic acid) composition according to claim 1,
wherein the monomer (C) having the biphenyl skeleton includes,
an aromatic tetracarboxylic dianhydride selected from the group consisting of 4,4′-bis(3,4-dicarboxyphenoxy)biphenyl dianhydride, 2,2′,3,3′-biphenyltetracarboxylic dianhydride, and 3,3′,4,4′-biphenyltetracarboxylic dianhydride, or
an aromatic diamine selected from the group consisting of 4,4′-bis(3-aminophenoxy)biphenyl, 4,4′-bis(4-aminophenoxy)biphenyl, 3,3′-bis(4-aminophenoxy)biphenyl, and 2,2′-bis(trifluoromethyl)-1, 1′-biphenyl-4,4′-diamine.

8. The poly(amic acid) composition according to claim 1,
wherein the aromatic monomer includes,
relative to the total amount of the monomers constituting the poly(amic acid),
40 to 70 mol % of the monomer (A) having the diphenyl ether skeleton represented by General formula (1) or (2), the monomer (A) not having a biphenyl skeleton or a benzophenone skeleton,
5 to 30 mol % of the monomer (B) having the benzophenone skeleton, and
25 to 45 mol % of the monomer (C) having the biphenyl skeleton.

9. The poly(amic acid) composition according to claim 1,
wherein a solution prepared by dissolving the poly(amic acid) so as to have a concentration of the poly(amic acid) of 0.5 g/dL in N-methyl-2-pyrrolidone (NMP) has an intrinsic viscosity (n) of 0.4 to 1.5 dL/g measured at 25° C. using an Ubbelohde viscosity tube.

10. The poly(amic acid) composition according to claim 1,
further comprising a solvent.

11. The poly(amic acid) composition according to claim 10,
wherein the solvent includes one or more selected from the group consisting of an aprotic solvent and an alcohol-based solvent.

12. The poly(amic acid) composition according to claim 1,
wherein a polyimide film obtained by imidizing the poly(amic acid) composition has a glass transition temperature of 130° C. or more and less than 260° C.

13. The poly(amic acid) composition according to claim 1,
wherein a polyimide film obtained by imidizing the poly(amic acid) composition has, in air atmosphere, a temperature of 5% weight loss of 300° C. or more.

14. The poly(amic acid) composition according to claim 1,
wherein, in a case of imidizing the poly(amic acid) composition to form a film of 2.0 cm×2.0 cm×thickness of 20 μm, the film has a dissolution ratio of 60% or more measured by immersing the film in N-methyl-2-pyrrolidone at 80° C. for 20 minutes and subsequent filtration through filter paper, the dissolution ratio being represented by Expression (1) below,
dissolution ratio (%)={1−[(weight of filter paper after filtration and drying)−(weight of filter paper before use)]/(weight of film before immersion)}×100. (1)

15. A polyimide composition comprising a polyimide,
wherein monomers constituting the polyimide include, relative to a total amount of the monomers constituting the polyimide, 95 mol % or more of an aromatic monomer having a main chain not having an aliphatic chain having 3 or more carbon atoms,
the aromatic monomer includes,
relative to the total amount of the monomers constituting the polyimide,
40 to 95 mol % of a monomer (A) having a diphenyl ether skeleton represented by General formula (1) or (2), the monomer (A) not having a biphenyl skeleton or a benzophenone skeleton,
0 to 60 mol % of a monomer (B) having a benzophenone skeleton, and
0 to 60 mol % of a monomer (C) having a biphenyl skeleton,
the monomer (A) having the diphenyl ether skeleton includes, relative to the total amount of the monomers constituting the polyimide, 20 mol % or more of a monomer (A-1) having three or more aromatic rings, and
a molar ratio of a diamine to a tetracarboxylic dianhydride satisfies diamine/tetracarboxylic dianhydride=0.90 to 0.999, the diamine and the tetracarboxylic dianhydride serving as the monomers constituting the poly(amic acid),

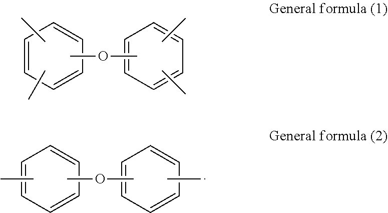

16. An adhesive comprising:
the polyimide composition according to claim 15.

17. The adhesive according to claim 16,
wherein the adhesive is an adhesive for a semiconductor member, an adhesive for a flexible printed substrate, an adhesive for a coverlay film, or an adhesive for a bonding sheet.

18. A laminate comprising:
a substrate; and
a resin layer disposed on the substrate and including the polyimide composition according to claim 15.
